(19) United States
(12) Patent Application Publication
(10) Pub. No.: US 2017/0187200 A1
(43) Pub. Date: Jun. 29, 2017

(54) Charger Communication by Load Modulation

(71) Applicant: Dialog Semiconductor (UK) Limited, London (GB)

(72) Inventors: Alan Somerville, Chippenham (GB); Julian Tyrrell, Cricklade (GB)

(21) Appl. No.: 14/980,067

(22) Filed: Dec. 28, 2015

(51) Int. Cl. H02J 7/00

(52) U.S. Cl. CPC H02J 7/007; H02J 7/0052; H02J 2007/0062

(57) ABSTRACT

A method and circuit that allows a charger port to source a slow charging voltage and current for one type of portable device and an adjustable voltage and current for a second type of portable device. The second type of portable device communicates with the charger port to establish a voltage and current that the portable device is capable of accepting. The portable device communicates with a charger port by load modulation structured for establishing a communications protocol for communicating a voltage and current level acceptable to the portable device.

### TECHNICAL FIELD

This disclosure relates generally to a battery charging method and circuit. More particularly, this disclosure relates to a battery charging method and circuit having a communication protocol between a battery charging control circuit and a primary side control circuit using load current modulation.

### BACKGROUND

To charge a battery as fast as possible, the charging current needs to have a magnitude that is relatively very large but with a magnitude that will not damage the battery. For a large proportion of portable devices, the charging is achieved by connecting the portable device to an external charger port through the Universal Serial Bus (USB) cable and connector.

The USB Battery Charging Specification, Revision 1.2, USB Implementers Forum Inc., Beaverton, Oreg., pp.: 40-42, Dec. 7, 2010 set limits that an external supply that is termed as charger port may supply to a portable device. The maximum supply voltage set provided by the charger port is 5.25V and the current ranges from 1.5 A-5.0 A. This current range limits the current available to charge a battery. Simply drawing more current from the external charger port cannot provide a sufficient voltage for battery charging due to the current/resistance (IR) drop in the USB cable. To transfer more power from the external charger port to the portable device charging circuitry, the voltage supplied by the charger must be increased. This allows more power to be transferred without the increase in the losses due to the relatively high resistance USB cable. However simply sourcing a higher voltage from the charger port with a USB connector could cause damage to portable devices, if they were connected to the supply expecting a USB charger port having the output voltage and current that met the USB specification for charging.

### SUMMARY

An object of this disclosure is to provide a method and circuit that allows a charger port to source a slow charging voltage and current for one type of portable device and a adjustable voltage and current for a second type of portable device.

Another object of this disclosure is provide a method and circuit that allows the second type of portable device to communicate with a charger port to establish a voltage and current that the portable device is capable of accepting.

Further, another object of this disclosure is to provide a circuit and method whereby a portable device communicates with a charger port by load modulation structured for establishing a communications protocol for communicating a voltage and current level acceptable to the portable device.

To accomplish at least one of these objects, a charger port has an AC to DC power converter for converting an AC line voltage to an output DC line voltage that meets a specified input power voltage for a portable device to be plugged into the charger port. The charger port has a controller circuit configured for sensing an output voltage and current of AC to DC power converter. The controller has a presence sensor configured for sensing the presence of the portable device. A presence signal from the presence sensor is an input to a timer that is triggered when the presence signal is activated. The timer provides an inrush current delay time to wait for power circuitry of the portable device to stabilize.

The charger port has a conditioning circuit that senses the output voltage and current to generate a feedback signal. The feedback signal is compared to a reference signal in a regulation circuit that generates a control signal for a pulse width modulation control circuit. The pulse modulation control circuit is configured for generating a driving signal for a switching circuit of the AC to DC power converter.

The charger port includes a load sensing circuit that senses changes in the output current of the AC to DC power converter to determine changes in the load current of the portable device. The load sensing circuit translates the changes in load current in a digital signal that is the output of the load sensing circuit. The output of the timer and the digital signal output of the load sensing circuit are the inputs to a data sensing circuit. At an expiration of an inrush current delay time, the data sensing circuit begins attempting to detect a valid data signal from the load sensing circuit. If a valid data signal is not sensed, the AC to DC power converter is operated at its specified operating conditions. When a valid data signal is received, the data signals are accumulated and transferred to a data decode circuit. The data decode circuit interprets the data commands in the data signals as a voltage and current level to be generated by the AC to DC power converter. The voltage and current level is transferred to an output voltage and control circuit that generates the necessary signals to the regulation circuit. The regulation circuit generates the control signal for a pulse width modulation control circuit that controls the switching circuit of the control signal for a pulse width modulation control circuit to set the output voltage and current to a level other than the slow charging voltage and current level of the portable device.

To accomplish at least one of these objects, the portable device has a control circuit configured for generating a control signal for driving a switched load circuit. The control signal activates and deactivates the switched load circuit for modulating the input load current for transferring data signals from the portable device to the port charger. The control circuit has a plug sensing circuit configured for determining that the portable device is connected to the port charger. If the portable device is not connected to the port charger, the control circuit generates deactivates a DC/DC power converter provides the charging voltage and current for charging a battery within the portable device. If the plug sensing circuit indicates that the plug is connected to connect the portable device to the charger port and that the battery is to be recharged, an inrush current timer circuit is triggered. The timer is set to delay the transfer of digital data signals indicating the voltage and current level required by the portable device for fast charging of the battery of the portable device until the inrush current to the DC/DC power converter has ended. At the end of the inrush current time, a switch controller accesses a command store to retrieve the digital data code for the voltage and current level required by the portable device for fast charging of the battery of the portable device. The digital data code is transferred to a data encoder to encode digital data code to generate the data signals that will be transmitted from the portable device. The encoded data signals are transferred to the switch controller. The switch controller then sends the encoded data signals to the switched load circuit to activate and deactivate the switched load circuit to modulate the load current with the encoded data signals for transmission to the charger port.

To accomplish at least one of these objects, a charging apparatus includes a portable device, a charger port, and a cable pluggably connected to the portable device and/or to the charger port. If the cable has two plugs, it will be pluggable to the portable device and the charger port. If the cable has one plug one end of the cable is permanently attached to the portable device or the charger port. The charger port and portable device are as described above for transmitting communicating a voltage and current level acceptable to the portable device from the charger port.

To accomplish at least one of these objects, a method for rapidly charging a battery within a portable device begins with plugging the portable device into an external supply or charger port. The charger port sources the slow charging voltage and current required by the portable device. A wait time is set to delay communication during a current inrush time. When the wait time has elapsed, the charger port senses the external current to detect any load change. If there is a load change, the load change is evaluated to determine if it is valid data and if the load change is valid data, the data pulses of the data are accumulated. The data pulses are decoded to determine the required voltage and current required by the portable device for fast charging. The charger port sets the required voltage and current for the portable device. The charger port then monitors the load current for any changes in load current indicating valid data. If there is valid data, the data is decoded and interpreted as the required voltage and current to be generated for the portable device. If the data is decoded as the slow charging voltage and current for normal operation of the portable device, the charger port resumes providing the slow charging voltage and current. When the portable device is unplugged, the charger port is deactivated.

The portable device generates the command data and modulates the load current after the inrush current wait time has elapsed. At the elapsing of the inrush current wait time, the portable device retrieves the command for the voltage and current for the rapid charging of the battery from a command storage device. The command is encoded and the load current is then modulated with the encoded data for transmission to the charger port by the portable device. The charger port responds with the rapid charging voltage and current for charging the battery. When the battery is charged, the portable device retrieves a command for resumption of the slow charging voltage and current for the operation of the portable device. The command is then encoded and the load current modulated with the encoded data for the resumption of the slow charging voltage and current for transmission to the charger port. The charger port responds with the resumption of the slow charging voltage and current for the portable device and maintains the slow charging voltage and current until the portable device is unplugged from the charger port and powered from the battery.

### BRIEF DESCRIPTION OF THE DRAWINGS

FIG. 1 is schematic diagram of a charging apparatus embodying the principles of the present disclosure.

FIG. 2 is a block diagram of an AC/DC power supply control circuit of FIG. 1 embodying the principles of the present disclosure.

FIG. 3 is a block diagram of a power control circuit of the portable device of FIG. 1 embodying the principles of the present disclosure.

FIG. 4 is a plot of the output voltage versus the load current of the charging port embodying the principles of the present disclosure.

FIGS. 5a, 5b, and 5c are plots of the load current over time illustrating the categories of modulation of the load current of the charging apparatus embodying the principles of the present invention.

FIGS. 6 and 7 are flowcharts of a method for rapidly charging a battery in a portable device embodying the principles of the present invention.

### DETAILED DESCRIPTION

The method and circuit that embodies the principals of this invention configures an external power supply or charger port for sourcing a slow charging voltage and current for one type of portable device that complies with the USB Battery Charging Specification and a second type portable that provides a variable voltage and current. The external power supply is commonly referred to as a charger port. The second type of portable device communicates with the charger port to establish a voltage and current that the portable device is capable of accepting. The portable device is configured for modulating the load current sourced from the charger port. The charger port detects the modulation of the load current to establish a communications protocol for communicating the voltage and current level acceptable to the portable device.

The portable device modulates the load current between two arbitrary current values (e.g. 100 mA and 200 mA). The portable device is configured for modulating the load current employing a digital amplitude modulated signal, a digital pulse frequency modulated signal, pulse position modulated signal, or a load pulse width modulated signal. The coded digital signal sequence is received and detected by the charger port. The charger port then decodes the coded digital signal and then determines that the portable device being charged is tolerant of a supply voltage of greater than the slow charging voltage and current of the communication specification such as 5.0V for the USB specification. For example, a portable device that communicates by complying with the USB speciation and is a configured for tolerating a 20V input on the V_{BUS} line of the USB cable. The portable device transmits the load current modulated code to the charger port indicating the portable device can tolerate the 20V input voltage. Once identified that the portable device is tolerant of the high-voltage, the external charger port increases its output voltage to the requested level as communicated by the portable device. If the load on the charger drops to zero or the portable device communicates end of charge, the charger port returns the output voltage and current to comply with the USB specification. The zero load current or the portable device communication of the return to the USB specification guarantees that charger port is configured for providing the voltage and current to meet the USB specification. When another portable device is plugged into the charger port that is not tolerant of the high voltage, the charger port will have returned to the operating mode that meets the USB specification and the other portable device will not be damaged.

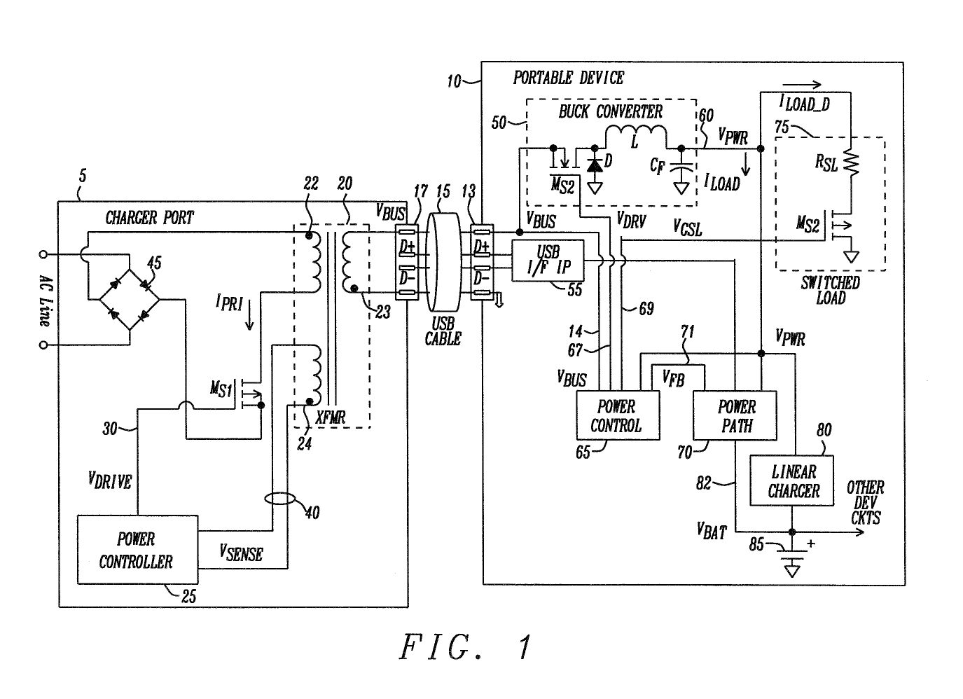

FIG. 1 is schematic diagram of a charging apparatus embodying the principles of the present disclosure. The charging apparatus has a charging port 5 that functions as an external power supply for a electronic portable device 10. A connecting cable 15 has plugs 13 and 17 that mate respectively to receptacles on portable device 10 and the charger port 5. The charger port has a bridge rectifier 45 with an input that connects directly to or through a plug/receptacle arrangement to an AC power line. A first output of the bridge rectifier 45 is connected to a first leg of a primary winding 22 of a flyback power transformer 20. A second leg of a primary winding 22 is connected to a drain of a NMOS switching transistor MS1. The source and body of the NMOS switching transistor MS1 is connected to the second output of the bridge rectifier 45. The gate of the NMOS switching transistor MS1 is connected the voltage drive line 30 to the charger port controller 25. The charger port control 25 generates the necessary timing and voltage to provide the voltage drive signal V_{DRIVE} to the gate of the NMOS switching transistor MS1.

A secondary sensing winding 24 has its first and second legs 40 connected to the charger port controller 25 to provide a sensing voltage V_{SENSE} to charger port controller 25. The primary current I_{PRI} can be determined from sensing voltage V_{SENSE} and the winding structure of the flyback power transformer 20 as is known in the art. The sensing voltage V_{SENSE} determines the magnitude of the load current I_{LOAD} by virtue of sensing the voltage present at the V_{BUS} line of the USB cable. If the transferred energy remains constant. That is the NMOS switching transistor MS1 is switching at a constant rate, then any change in the load current I_{LOAD} modifies the voltage present at the V_{BUS} line of the USB cable. Hence, the change in the voltage present at the V_{BUS} line of the USB cable changes the value of the sensing voltage V_{SENSE} by the turns ratio of the transformer 20.

The flyback power transformer 20 has the first leg of the secondary winding 23 connected to the plug/receptacle arrangement 17 that is connected to the voltage line V_{BUS} of the USB cable 15. The second leg of the secondary winding 23 is connected to the ground line of the USB cable 15. The data lines D+ and D− are not connected to any circuitry of the charger port, but maybe connected to other circuitry associated with the charger port.

As noted above the USB cable is connected through the plug/receptacle arrangement 13 to the portable device 10. The voltage line V_{BUS} is connected to the buck DC/DC converter 50 and to the power controller 65. The buck DC/DC converter 50 has a PMOS switching transistor M_{S2} that has its source and body connected to the voltage line V_{BUS}. The drain of the PMOS switching transistor M_{S2} is connected to the first leg of the inductor L. The common connection of the drain of the PMOS switching transistor M_{S2} and the first leg of the inductor L is connected to the cathode of the diode D. The anode of the diode D is connected to the ground reference source of the portable device 10. The second leg of the inductor L is connected to a first terminal of the filter capacitor C_{F}. The second terminal of the filter capacitor C_{F} is connected to the ground reference source for the portable device. The common connection of the second leg of the inductor L and the first terminal of the filter capacitor C_{F} is the output terminal 60 of the buck DC/DC converter 50 for providing the output voltage V_{PWR} for powering the portable device. The buck DC/DC converter 50 output voltage V_{PWR} is transferred to the power path circuit 70, the power controller 65, and the USB Implementers Forum (IF) intellectual property (IP) circuit 55.

The power path circuit 70 is the control mechanism to maintain the buck DC/DC converter 50 output voltage V_{PWR} for providing the voltage and current for charging the battery 85. The power path circuit 70 maintains the voltage and current of the output voltage V_{PWR} at a level to allow sufficient margin to the linear charger 80 to charge the battery 85. If there is excessive margin in the buck DC/DC converter 50 output voltage V_{PWR}, the portable device 10 operates inefficiently and excess power is dissipated as heat.

The power controller 65 is connected to receive the voltage from the USB cable voltage line V_{BUS} for detecting that the plug of the USB cable 15 and the receptacle 13 of the portable device are connected. When the plug of the USB cable 15 is attached to connect the charger port 5 to the portable device 10, an inrush current occurs to charge the capacitance of the load circuits and the filter capacitance of the buck DC/DC converter 50. The output voltage V_{PWR} from the buck DC/DC converter 50 is connected to the power controller 65 to sense the output voltage of the buck DC/DC converter 50 to determine the output drive signal 67 that is transferred to the gate of the PMOS transistor M_{S2}. The linear charger 80 receives the output voltage V_{PWR} conditions the voltage to provide the voltage and current for charging the battery 85.

In order to modulate the load current from the output voltage V_{PWR} from the buck DC/DC converter 50, the power controller 65 generates a load current modulation signal V_{LCMS} that is transferred on the connection 69 between from the power controller 65 and the switched load circuit. The switched load circuit 75 when activated increases the load current of the output voltage V_{PWR} from the buck DC/DC converter 50 by an amount I_{LOAD}_{_}_{D}. This increase in load current I_{LOAD}_{_}_{D} transferred back to the port charger 5 for sensing and decoding to determine the input voltage increase required to the portable device 15.

The switched load 75 has a resistor R_{SL} that has a first terminal connected to receive the output voltage V_{PWR} from the buck DC/DC converter 50. A second terminal of the resistor R_{SL} that is connected to a drain of an NMOS switching transistor M_{S3}. The source of the NMOS switching transistor M_{S3} is connected to the ground reference source. The gate of the NMOS switching transistor M_{S3} is connected through the connection 69 to the power controller 65 that generates a load current modulation signal V_{LCMS}. When the load current modulation signal V_{LCMS} is active, the NMOS switching transistor M_{S3} is turned on to allow the load current to be increased. The load current modulation signal V_{LCMS} is deactivated to turnoff the NMOS switching transistor M_{S3} to restore the load current to the current specified in the USB Battery Charging Specification.

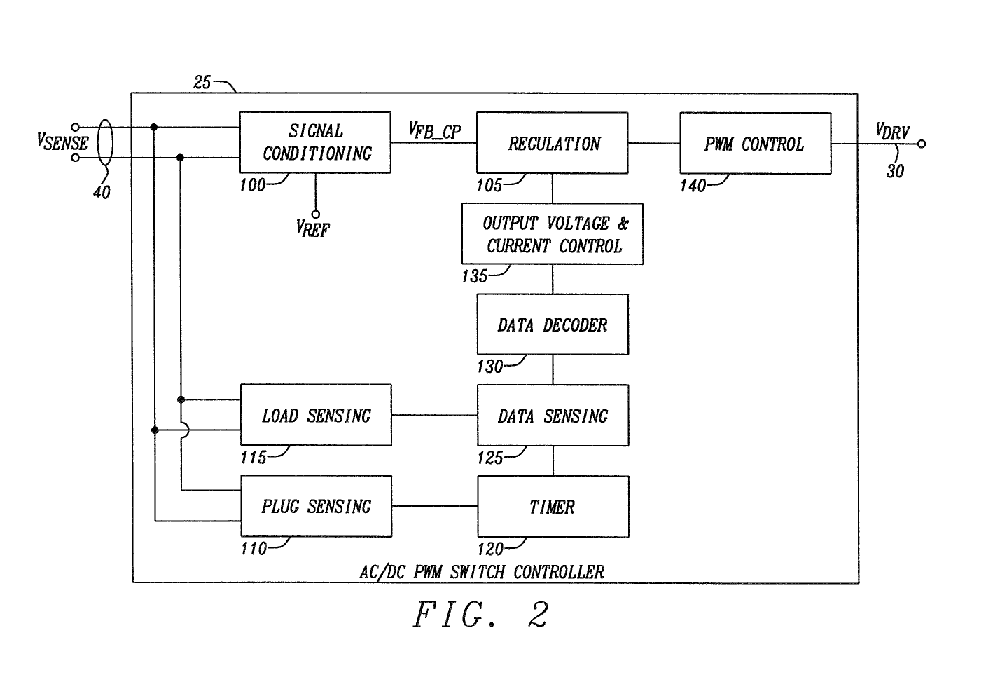

FIG. 2 is a block diagram of the AC/DC power supply control circuit 25 of FIG. 1. As described above the first and second legs 40 of the secondary sensing winding 24 provide the sensing voltage V_{SENSE} to the power supply controller 5. The sensing voltage V_{SENSE} is applied to the signal conditioning circuit 100, the plug sensing circuit 110, and the load sensing circuit 115. The signal conditioning circuit 100 further receives a reference voltage V_{REF} that is compared to the sensing voltage V_{SENSE} to determine an error voltage that is indicative of the difference of the voltage level of the voltage line V_{BUS} and the specified voltage as detailed in the USB Battery Charging Specification. The error voltage is to generate a feedback voltage V_{FBCP} at the output of the signal conditioning circuit 100 that is applied to the input of a regulation circuit 105. The regulation circuit is typically a proportional-integrative (PI) control loop that maintains the pulse width modulation controller 140 drive to reduce the feedback voltage V_{FBCP} error level. The ratio of proportionality and the integrator pole frequency are chosen to suit the external circuit components and the switching frequency of the NMOS switching transistor MS1.

The output signal of the regulation circuit 105 is the input to the pulse width modulation controller 140. Based on the output signal of the regulation circuit 105, the pulse width modulation controller 140 generates the necessary timing and voltage to provide the voltage drive signal V_{DRIVE} to the gate of the NMOS switching transistor MS1.

The plug sensing circuit 110 senses the change in the sensing voltage V_{SENSE} indicating that the USB cable 15 has been connected to the charger port 5. The output of the plug sensing circuit 110 is applied to a timer circuit 120 that activates when the USB cable 15 is connected to the charger port 5. The timer circuit 120 is set to provide a wait time for an inrush current to the portable device 10 to have stabilized to a steady load current I_{LOAD} within the portable device 10.

The load sensing circuit 115 also senses the change in the sensing voltage V_{SENSE} and converts the sensed changed to a digital signal that is transferred from the output of the load sensing circuit 115 to a data sensing circuit 125. The data sensing circuit 125 determines if the load changes occurring in the portable device 10 are a valid data signal indicating that the portable device 125 is transmitting data to the charger port 5. If the data is a valid data signal, the data sensing circuit 125 transfers the valid data to the data decoder 130. The data decoder 130 determines the output voltage and current levels that the portable device 10 can accept and conveys the decoded data to the output voltage and current controller 135. The output voltage and current controller 135 transfers adjustment signals to the regulation circuit 105 indicating the changes to be made to the output signal of the regulation circuit 105 to change the timing and voltage level of the voltage drive signal V_{DRIVE} to the gate of the NMOS switching transistor MS1. The changes in the voltage drive signal V_{DRIVE} increases the voltage at the USB cable voltage line V_{BUS} to more rapidly charge the battery 85.

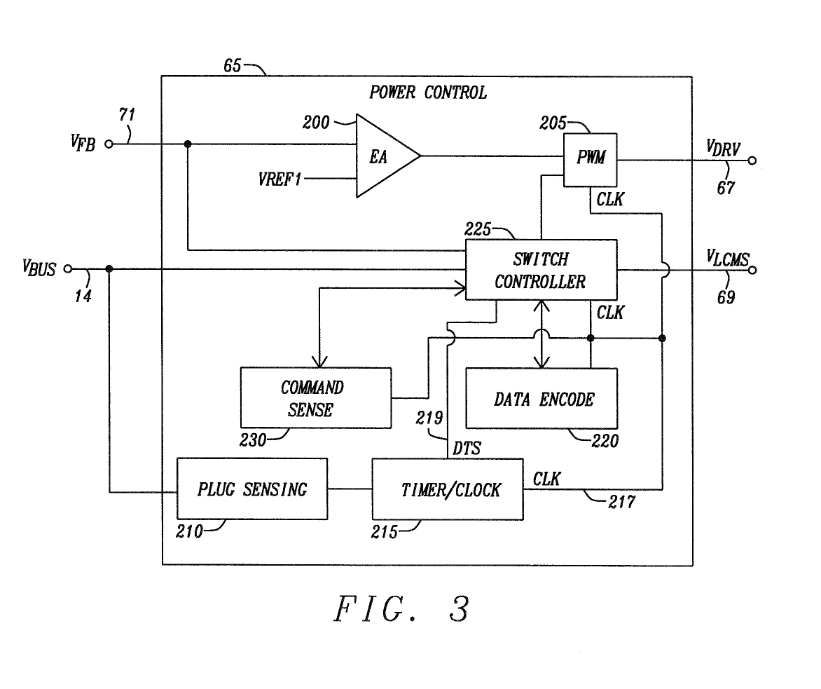

When the rapid charging is required by the portable device 10, the increase voltage is applied to the voltage line V_{BUS} of the USB cable 15 to be transferred to the input terminal of the buck DC/DC converter 50. The voltage line V_{BUS} is also connected to the power controller 65. FIG. 3 is a block diagram of a power controller 65 of the portable device 10 of FIG. 1. The voltage line V_{BUS} is the input to the plug sensing circuit 210. When the voltage level of the voltage line V_{BUS} is applied to the plug sensing circuit 210, the plug sensing circuit 210 generates a plug presence signal that is applied to the timer/clocking circuit 215. When the plug presence signal is active, the timer section of the timer/clocking circuit 215 is activated generate an inrush current delay time signal 219. The inrush current delay time signal 219 indicates that the voltage and current on the USB cable are changing rapidly and no load modulation signal should be transmitted. The timer 215 is set to provide a delay time that is longer than the time for the voltage and current provided by the charger port 5 to have settled to the levels that meet the requirements of the USB Battery Charging Specification. Once the delay time has elapsed the timer 215 deactivates the inrush current delay time signal.

The output voltage V_{PWR} is transferred to the power path circuit 70 is used to generate the feedback voltage V_{FBPD} that is transferred to the error amplifier 200. The feedback voltage V_{FBPD} is compared to a reference voltage V_{REF1} and a difference signal is generated between the two voltages. The difference signal is transferred to the pulse width modulator 205. The pulse width modulator 205 receives a clocking signal CLK from the timer/clock circuit and a control signal from the switch controller 225. The difference signal, the clocking signal CLK, and the control signal are combined to determine the output drive signal 67 that is transferred to the gate of the PMOS transistor M_{S2} of the buck DC/DC converter 50.

If the power controller 65 of the portable device 10 is to provide the load current modulation code, the switch controller 225 retrieves a command code 230 defining the required voltage level that the portable device 10 must receive for rapidly charging the battery 85. The switch controller 225 transfers the command code to the data encoder 220 that defines the switch timing required to generate the load current modulation signal V_{LCMS}. Once switch timing is created, the switch controller 225 generates and transfers the load current modulation signal V_{LCMS} to the connection 69 and thus to the switched load circuit 75.

When the battery 85 is charged, the power path 70 provides the feedback signal V_{FBPD} indicating the larger voltage for rapid charging is no longer needed. The switch controller 225 retrieved a command from the command store 230 indicating that the charger port 5 is to resume its specified operation parameters. The resume specified operation command is encoded in data encoder 220 and the switch controller 225 transfers the load current modulation signal V_{LCMS} to the connection 69 and thus to the switched load circuit 75. The charger port receives and decodes the command from the load modulation and resumes the slow charging voltage and current of the USB Battery Charging Specification. Since the buck converter 50 provides the output voltage V_{PWR} at the output terminal 60 to allow the charger minimum headroom for efficiency. The increased the voltage line V_{BUS} of the USB cable 15 allows for the increased current/resistance (IR) drop. The linear regulator charging the battery depends on the state of charge.

A command message structure is a header, a payload, and a trailer. The header would be a message start code (START) followed by a payload message containing the command and any qualifiers for the command. Finally, a trailer completes the message with a structure such as an error correction/detection code (CHECKSUM). Once the message is sent, the message start code is periodically repeated to confirm the validity of the last message. Any other repeated validity code (i.e. OK) maybe transmitted to indicate validity of the message. If the validity code is not received, the charger port reverts back to the standard voltage level (5V) of the voltage line V_{BUS} of the USB cable 15 after a timeout period. The correct reception of a message is detected by the VBUS voltage changing, if this does not the power control circuit 65 can take appropriate action and re-send the message.

The essence of the present disclosure is a digital communication using switch load currents between two different values. The values chosen have to be sensed within a defined tolerance. For example, if the current modulation had a first load current of 100 mA and a second load current of 200 mA, the load sensing circuit 115 of FIG. 2 could have a +/−50 mA margin to accommodate noise, offsets, etc. By using a non-zero value for the switched load currents, the plug sensing circuit 110 is able to detect that a portable device of FIG. 1 has been connected to the USB receptacle 17 of the charger port 5. This is not a prerequisite for this scheme as zero load could be a valid level and be used as part of the communication protocol. However, in a preferred implementation, a zero-load condition is used to indicate that the charger port 15 is not connected to a portable device 10 and must provide a USB compliant voltage to the voltage line V_{BUS} of the USB cable 15.

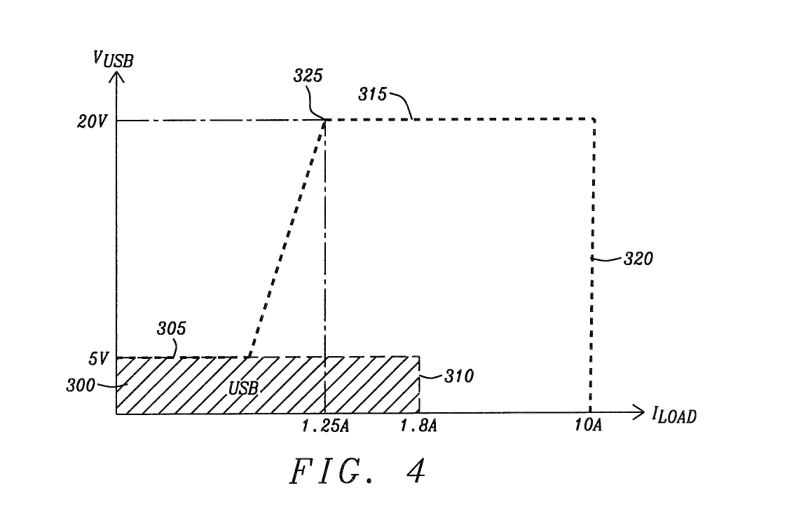

FIG. 4 is a plot of the output voltage to the voltage line V_{BUS} versus the load current I_{LOADCP} of the charging port 5. The charger port 5 will provide a voltage V_{BUS} and current I_{LOADCP} that complies with the USB Battery Charging Specification. After the power control circuit 65 of the portable device 10 has transmitted the load current modulation code and the charger port controller 25 received, sensed, and decoded the load current modulation code, charger port changes to the voltage and current at the voltage line V_{BUS} of the USB cable 15 to allow faster battery charging of the battery 85. The portable device 10 verifies that the data transmission has been accepted by the charger port when power control circuit receives a higher voltage level at the voltage line V_{BUS} of the USB cable 15 as determined by the switch controller 225 of the power controller 65, when the load current increases. Referring now to FIG. 4, the charger port 5 detects that the USB cable 15 has been plugged to connected the charger port 5 to the portable device 10. The charger port 5 is activated to set the voltage line V_{BUS} of the USB cable 15 to the voltage 305 of +5V±0.25V as designated by the USB Battery Charging Specification. The load current will be established by the portable device, but will be limited to a maximum of 1.8 A 310.

Once the load current modulated code is received, sensed, and decoded by the charger port 5, the charger port 5, then establishes the output voltage and current 325 applied to the voltage line V_{BUS} of the USB cable 15 to be set to a maximum voltage 315 of approximately 20V. The load current will be established by the portable device 10, but will be limited to a maximum current 320 of approximately 10 A. The maximum voltage and current applied at the output of the charger port 5 to the voltage line V_{BUS} of the USB cable 15 is selected based on the safety issues based on the power dissipation of the components of the charger port 5 and the portable device 10

As described, the output voltage of the charger port 5 applied to the voltage line V_{BUS} of the USB cable 15 may change from 5V to 20V. If the current through the USB cable 15 were allowed to change from 1.8 A to 10 A and the USB cable has a 28AWG wire that is 2 m in length, the resistance of the two-meter cable is approximately ½ ohm. This can be calculated to be a 5V drop across the cable, which at 10 A current through the cable means a 50 W dissipation in the cable. This is not permitted and in fact may cause damage to the cable and the plug. If the output voltage of the charger port 5 is 20V and the output current of the charger port 5 is then limited to a lower value, for instance 1.25 A 325 and the voltage drop across the cable is now 625 mV. The voltage presented to the buck DC/DC converter 50 is now 19.375V and the output voltage and current is adjusted to provide the amount of voltage and current to meet the requirements for rapidly charging the battery 85. The load current modulated code is defined to set the limits of the charger port 5 to provide the higher amplitude voltage while limiting the current to have an acceptable IR voltage drop across the USB cable 15.

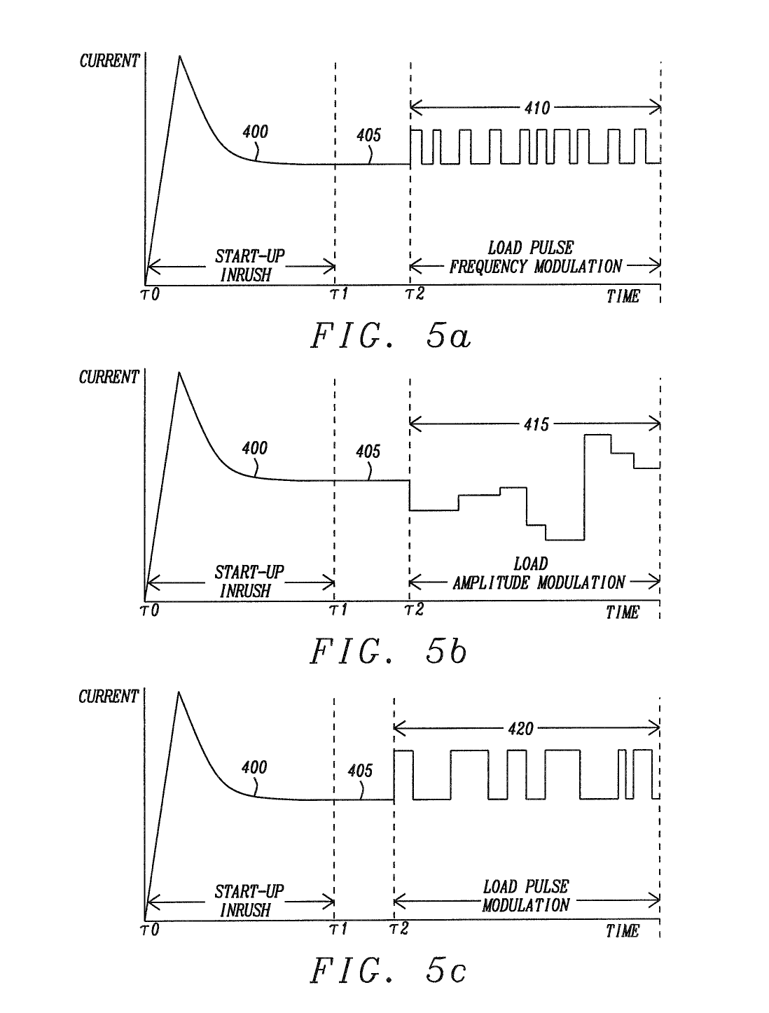

FIGS. 5a, 5b, and 5c are plots of the load current over time illustrating the categories of load current modulation of the charging apparatus embodying the principles of the present invention. When the USB cable 15 connects the charger port 5 to the portable device 10, the inrush current begins at the time τ0 and ends at the time τ1. Between the time τ1 and time τ2, a buffer time is implemented to construct the inrush current delay time signal 219. After the time τ2, the specified operation command is encoded and the load current is modulated to form the load current modulated code for transmission. In FIG. 5a, the load current modulated code is a pulse frequency modulated signal 410. In FIG. 5b, the load current modulated code is a pulse amplitude modulated signal 415. In FIG. 5c, the load current modulated code is a pulse position modulated signal 420.

The symbol structure of load current modulated code maybe any suitable code. The commands may include a preamble defining a start of message followed by a payload defining the current and voltage to be provided by the charger port and ending with a trailer including an error correction/detection code. Alternately, a unique bit pattern can be defined for each command for defining the current and voltage to be provided by the charger port. The modulation scheme used for transferring the data could be pulse width modulation, pulse position modulation, or Manchester-encoded serial data. The number of switched levels is not limited to two and more could be used if required with a more elaborate modulation scheme. The essence of using a complex digital modulation is that any portable device not configured for handling any voltages not specific in the USB Battery Charging Specification is able to be connected to the charger port and not inadvertently change the supplied output voltage.

The data transmission rate is chosen such that the characteristics of the charger port and the portable device battery charger are accounted for. The data transmission rate must be within the frequency response bandwidth of both the charger port and the portable device battery charger. In practice, the data transmission is required to be fast enough to minimize the delay time before high power charging can begin but slow enough to be detected by the charger port. Environmental considerations such electromagnetic interference that must be minimized. A data transmission rate of from approximately 1 kHz to approximately 10 kHz is deemed sufficient for this application.

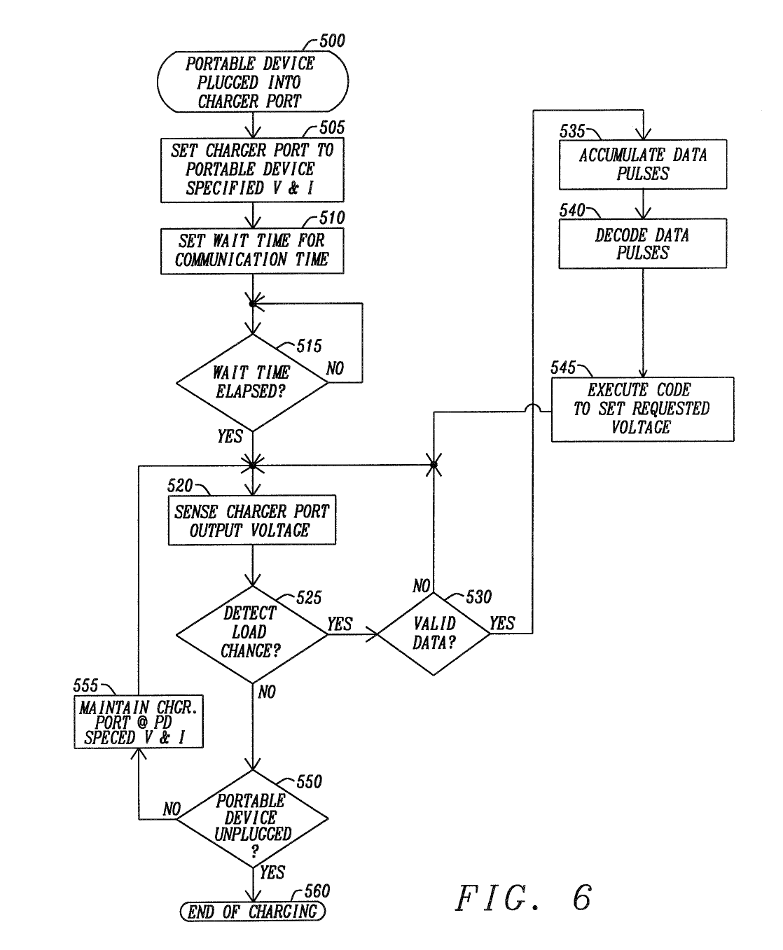

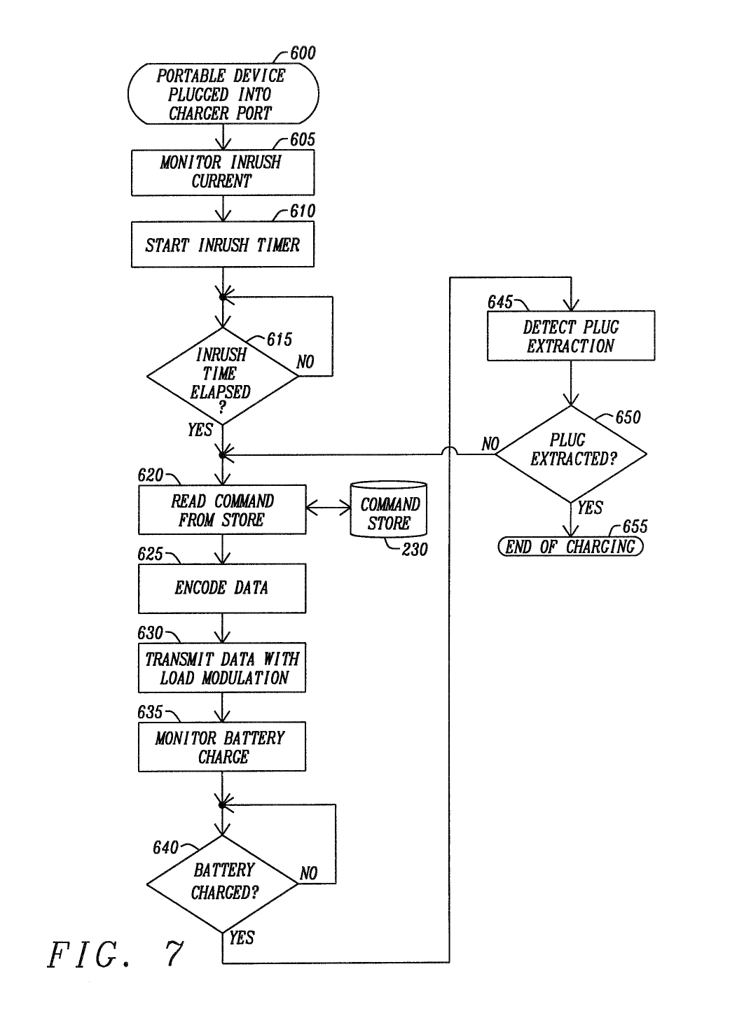

FIGS. 6 and 7 are flowcharts of a method for rapidly charging a battery in a portable device. FIG. 6 is the explanation of the method of the operation of the charger port. The battery powered USB portable device is plugged (Box 500) through a USB cable to a charger port. The charger port begins supplying (Box 505) the voltage and current to meet the requirement as specified by the USB Battery Charging Specification. The charger port then sets (Box 510) a timer for an inrush current delay time and the charger port examines (Box 515) the timer to see if the inrush current delay time has elapsed. When the inrush current delay time has elapsed, the output voltage of the charger port applied to the voltage line V_{BUS} of the USB cable is sensed (Box 520) to determine (Box 525) that there has been a load change.

If there is a load change sensed (Box 520), the changes in the load current are examined (Box 530) to determine if the changes in load current represent valid data. If it not valid data a next sampling of the current is sensed (Box 520) to determine (Box 525) if the load current is changing. If the data is valid, the pulses of a sequential set of valid data are accumulated (Box 535) and then decoded (Box 540). The command defined by the code is executed (Box 545) to set the port charger is set to the requested voltage and current. The output voltage of the charger port applied to the voltage line V_{BUS} of the USB cable is sensed (Box 520) to determine (Box 525) that there has been a load change.

If there is no load change sensed (Box 520) determining (Box 525) that there is no load change, the plug presence is examined (Box 550) to determine if the portable device has been unplugged. If the portable device has been unplugged, the charger port maintains (Box 555) the voltage and current as specified by the portable device. If the portable device is unplugged (Box 550) from the charger port, the charging cycle is ended (Box 560)

FIG. 7 is the explanation of the method of the operation of the portable device to generate and transmit the load current modulation code to the charger port. The method begins when the USB cable connects (Box 600) the portable device to the charger port. The inrush current is monitored (Box 605) and the inrush delay time is started (Box 610). The inrush timer is monitored (Box 615) to determined that that the inrush time has elapsed. When the inrush time has elapsed, a command is read (Box 620) from the command store 230. The command data is encoded (Box 625) and transmitted (Box 630) to the charger port using modulation of the load current. The battery charge is monitored (Box 635) to determine (Box 640) if the battery is charged. When the battery is charged, the plug presence detect is queried (Box 645) to determine (Box 650) that the plug has been extracted and the USB cable is disconnecting the portable device from the charger port. If the plug is not disconnected, the command store 230 is read (Box 620) to extract a command for instructing the charger port to return to the slow charging voltage and current limits of the USB Battery Charging Specification. The command data is again encoded (Box 625) and transmitted (Box 630) to the charger port using modulation of the load current.

The battery charge is monitored (Box 635) to determine (Box 640) if the battery is charged. When it is determined (Box 650) that the plug has been extracted and the USB cable is disconnecting the portable device from the charger port, the charging cycle is ended.

While this disclosure has been particularly shown and described with reference to the preferred embodiments thereof, it will be understood by those skilled in the art that various changes in form and details may be made without departing from the spirit and scope of the disclosure. For instance the charging is specified to comply with the USB Battery Charging specification and the charger port is connected with a USB cable to the portable device. Any communication protocol that has a power transfer connection incorporated in the physical structure is in keeping with the intent of this disclosure.

What is claimed is:

1. A charger port comprising:
an AC to DC power converter configured for converting an AC voltage to an output dc voltage and current and providing the output dc voltage and current to a portable device that is connected to the charger port;
a charger power controller comprising:
a load sensing circuit configured for sensing changes in the output current of the AC to DC power converter to determine changes in the load current of the portable device and generating a load current data signal;
a data sensing circuit is configured for receiving the load current data signal and for detecting a valid data signal from the load sensing circuit;
a data decode circuit configured for receiving the valid data signal for interpreting data commands in the valid data signals indicating voltage and current levels to be generated by the AC to DC power converter.

2. The charger port of claim 1 wherein the AC to DC power converter comprises:
a rectifier bridge configured for rectifying an input AC voltage to a rectified AC voltage;
a flyback transformer comprising:
a primary winding configured for receiving the receiving the rectified AC voltage at a first leg,
a secondary winding configured for receiving the rectified AC voltage inductively coupled from the primary winding, and
a sensing winding configured for receiving the rectified AC voltage inductively coupled from the primary winding and modified by variations in a load current through the secondary winding and developing a sensing voltage that indicates changes in the output current of the AC to DC power converter to determine changes in the load current of the portable device.

3. The charger port of claim 1 wherein the charger power controller comprises a presence sensor configured for sensing the presence of the portable device.

4. The charger port of claim 3 wherein the charger power controller further comprises a timer configured for receiving the presence signal from the presence sensor and configured for being triggered when the presence signal is activated to provide an inrush current delay time to wait for power circuitry of the portable device to stabilize.

5. The charger port of claim 4 wherein the charger power controller further comprises a conditioning circuit that senses the output voltage and current of the AC/DC power converter to generate a feedback signal

6. The charger port of claim 5 wherein the charger power controller further comprises that regulation circuit configured for receiving the feedback signal from the conditioning circuit and for comparing the feedback signal to a reference signal for generating an error control signal;

7. The charger port of claim 6 wherein the charger power controller further comprises a pulse width modulation control circuit configured for receiving the error control signal from the conditioning circuit and for generating a driving signal for a switching circuit of the AC to DC power converter.

8. The charger port of claim 1 wherein when the valid data signal is not sensed, the AC to DC power converter is operated at its default operating conditions.

9. A portable device comprising:
a power converter configured for converting a voltage and a load current provided by a charger port to a voltage required by the portable device for operation and for charging a battery;
a load switching circuit configured for receiving a control signal that is constructed for modulating the load current for transmission of digital data signals to the charger port;
a power control circuit configured for generating the control signal for driving the switched load circuit to activate and deactivate the switched load circuit for modulating the load current for transferring the digital data signals to the port charger.

10. The portable device of claim 8 wherein the power control circuit comprises:
a command store retaining a digital command code for a voltage and current level required by the portable device for fast charging of the battery of the portable device;
a switch controller configured for receiving the digital command code from the command store;
a data encoder configured for receiving the digital command code from the switch controller and for encoding the digital data code to generate the control signals for modulating the load current level, and for transferring the encoded control signals to the switch controller wherein the switch controller is configured for transferring the control signals to the switched load circuit to activate and deactivate the switched load circuit to modulate the load current with the control signals for transmission to the charger port.

11. The portable device of claim 9 wherein the power control circuit further comprises:
a plug sensing circuit configured for determining that the portable device is connected to the port charger and generating a plug presence signal; and
an inrush current timer configured for receiving the plug presence signal such that when the plug presence signal indicates that the portable device is connected to the charger port and a low battery signal indicates that a battery of the portable device is to be recharged, the inrush current timer is configured for triggering the inrush current timer circuit for setting a delay for transferring of digital control signals until the inrush current to the DC/DC power converter has ended.

12. The portable device of claim 10 wherein the power control circuit further comprises:
an error amplifier configured for receiving a feedback signal from the power converter indicating a voltage and current level of the output of the power converter and for comparing the feedback signal with a reference signal level for generating an error signal indicating a difference of the output voltage and current level of the power converter with a specified output voltage and current level; and
a pulse width modulator configured for receiving the error signal from the error amplifier and for determining a pulse width of a driver signal that activates and deactivates a switch within the power converter for controlling the output voltage and current of the power converter;
wherein the switch controller is further configured for receiving the voltage and load current levels provided by a charger port for determining that the charger port has received the load current modulated control signal and has started provided voltage and current levels designated by the command signals.

13. The portable device of claim 11 wherein when the portable device is not connected to the port charger, the switch control circuit is configured for generating a deactivation signal that is transferred to the pulse width modulation to deactivate the power converter and the portable device operates from the battery.

14. An electronic apparatus comprising:
a charger port comprising:
an AC to DC power converter configured for converting an AC voltage to an output dc voltage and current and providing the output dc voltage and current to an output receptacle;
a charger power controller comprising:
a load sensing circuit configured for sensing changes in the output current of the AC to DC power converter to determine changes in load current present at the output receptacle;
a data sensing circuit is configured for receiving the load current data signal and for detecting a valid data signal from the load sensing circuit;
a data decode circuit configured for receiving the valid data signal for interpreting data commands in the valid data signals indicating voltage and current levels to be generated by the AC to DC power; and
a portable device comprising:
a power converter configured for receiving and converting the output voltage and current provided by a charger port through the receptacle to a voltage required by the portable device for operation and for charging a battery,
a load switching circuit configured for receiving a control signal that is constructed for modulating the load current for transmission of digital data signals to the charger port, and
a power control circuit configured for generating the control signal for driving the switched load circuit to activate and deactivate the switched load circuit for modulating the load current for transferring the digital data signals to the port charger.

15. The electronic apparatus of claim 14 wherein the AC to DC power converter comprises:
a rectifier bridge configured for rectifying an input AC voltage to a rectified AC voltage;
a flyback transformer comprising:
a primary winding configured for receiving the receiving the rectified AC voltage at a first leg,
a secondary winding configured for receiving the rectified AC voltage inductively coupled from the primary winding, and
a sensing winding configured for receiving the rectified AC voltage inductively coupled from the primary winding and modified by variations in a load current through the secondary winding and developing a sensing voltage that indicates changes in the output current of the AC to DC power converter to determine changes in the load current of the portable device.

16. The electronic apparatus of claim 14 wherein the charger power controller comprises a presence sensor configured for sensing the presence of the portable device.

17. The electronic apparatus of claim 16 wherein the charger power controller further comprises a timer configured for receiving the presence signal from the presence sensor and configured for being triggered when the presence signal is activated to provide an inrush current delay time to wait for power circuitry of the portable device to stabilize.

18. The electronic apparatus of claim 17 wherein the charger power controller further comprises a conditioning circuit that senses the output voltage and current of the AC/DC power converter to generate a feedback signal

19. The electronic apparatus of claim 18 wherein the charger power controller further comprises that regulation circuit configured for receiving the feedback signal from the conditioning circuit and for comparing the feedback signal to a reference signal for generating an error control signal;

20. The electronic apparatus of claim 19 wherein the charger power controller further comprises a pulse width modulation control circuit configured for receiving the error control signal from the conditioning circuit and for generating a driving signal for 8 switching circuit of the AC to DC power converter.

21. The electronic apparatus of claim 14 wherein when the valid data signal is not sensed, the AC to DC power converter is operated at its specified operating conditions.

22. The electronic apparatus of claim 14 wherein the power control circuit comprises:
a command store retaining a digital command code for a voltage and current level required by the portable device for fast charging of the battery of the portable device;
a switch controller configured for receiving the digital command code from the command store;
a data encoder configured for receiving the digital command code from the switch controller and for encoding the digital data code to generate the control signals for modulating the load current level, and for transferring the encoded control signals to the switch controller wherein the switch controller is configured for transferring the control signals to the switched load circuit to activate and deactivate the switched load circuit to modulate the load current with the control signals for transmission to the charger port.

23. The electronic apparatus of claim 22 wherein the power control circuit further comprises:
a plug sensing circuit configured for determining that the portable device is connected to the port charger and generating a plug presence signal; and
an inrush current timer configured for receiving the plug presence signal such that when the plug presence signal indicates that the portable device is connected to the charger port and a low battery signal indicates that a battery of the portable device is to be recharged, the inrush current timer is configured for triggering the inrush current timer circuit for setting a delay for transferring of digital control signals until the inrush current to the DC/DC power converter has ended.

24. The electronic apparatus of claim 23 wherein the power control circuit further comprises:
an error amplifier configured for receiving a feedback signal from the power converter indicating a voltage and current level of the output of the power converter and for comparing the feedback signal with a reference signal level for generating an error signal indicating a difference of the output voltage and current level of the power converter with a specified output voltage and current level; and
a pulse width modulator configured for receiving the error signal from the error amplifier and for determining a pulse width of a driver signal that activates and deactivates a switch within the power converter for controlling the output voltage and current of the power converter;
wherein the switch controller is further configured for receiving the voltage and load current levels provided by a charger port for determining that the charger port has received the load current modulated control signal and has started provided voltage and current levels designated by the command signals.

25. The electronic apparatus of claim 24 wherein when the portable device is not connected to the port charger, the switch control circuit is configured for generating a deactivation signal that is transferred to the pulse width modulation to deactivate the power converter and the portable device operates from the battery.

26. A method for rapidly charging a battery within a portable device comprising the steps of:
plugging the portable device into an external supply or charger port;
sourcing an slow charging voltage and current to the portable device from the charger port sensing by the charger port an output current from the charger port;
detecting any load change in the output current indicating a load modulating signal;
when there is a load change in the output current indicating a load modulating signal, evaluating the load modulating signal to determine if the load modulating signal is valid data;
when the load modulating signal is valid data, accumulating data determined to be valid data;
decoding the accumulated valid data to determine a fast charging voltage and current required by the portable device for fast charging the battery; and
setting the fast charging voltage and current for the portable device the by external supply.

27. The method for rapidly charging a battery of claim 26 further comprising:
sensing the that portable device has been plugged to the charger port;
setting a wait time to delay communication during a current inrush time of the portable device;
wherein the sensing by the charger port of the output current occurs when the wait time has elapsed,

28. The method for rapidly charging a battery of claim 26 further comprising the steps of:
monitoring the load current for any changes indicating the load modulating signal indicating valid data;
when there is valid data, decoding and interpreting the data;
when the data is decoded as indicating that the portable device requires the slow charging voltage and current, the charger port resumes providing the slow charging voltage and current; and
deactivating the charger port, when the portable device is unplugged.

29. The method for rapidly charging a battery of claim 28 further comprising the steps of:
when the inrush current wait time is elapsed, retrieving the command for the fast charging voltage and current from a command storage device;
encoding the command for the fast charging voltage and current; and
modulating the load current with the encoded data for transmission to the charger port by the portable device.

30. The method for rapidly charging a battery of claim 28 further comprising the steps of:
when the battery is charged, retrieving a command for resumption of providing the slow charging voltage and current;
encoding the command for resumption of providing the slow charging voltage and current and
modulating the load current with the encoded data for the resumption of providing the slow charging voltage and current for transmission to the charger port;
responding by the charger port with the resumption of the slow charging voltage and current for the portable device; and
maintaining the slow charging voltage and current until the portable device is unplugged from the charger port and powered from the battery.
